(19) United States
(12) Patent Application Publication
(10) Pub. No.: US 2021/0209716 A1
(43) Pub. Date: Jul. 8, 2021

(54) RESELL WAGER MARKET

(71) Applicant: Wallace K. Stuart, Los Angeles, CA (US)

(72) Inventor: Wallace K. Stuart, Los Angeles, CA (US)

(21) Appl. No.: 17/210,411

(22) Filed: Mar. 23, 2021

Related U.S. Application Data
(60) Provisional application No. 63/045,189, filed on Jun. 29, 2020.

(51) Int. Cl. G06Q 50/34; G06Q 40/04; G06Q 20/10; G06Q 20/40; G07F 17/32

(52) U.S. Cl. CPC G06Q 50/34; G06Q 40/04; G06Q 20/10; G06Q 20/18; G07F 17/3288; G07F 17/3225; G07F 17/3244; G06Q 20/40

(57) ABSTRACT

A system and internet-implemented method provides a wager market. The best mode comprises a market server, at least one casino computer, and at least two personal computers. The computers are configured so that the casino computer transmits a purchased wager to a first personal computer and the market server, the market server displays the wager on a website, a second personal computer accesses the website and transmits an offer for the wager to the first personal computer via the market server, the first personal computer transmits acceptance of the offer to the second personal computer via the market server, and the market server facilitates transfer of the wager. If the casino is not integrated with the system the seller lists the wager manually, and the bettors exchange money with an escrow payment system. The system is also configured to facilitate wager-for-wager barter.

### 1. FIELD OF THE INVENTION

This invention is in the field of methods and systems for wagering, specifically for novel methods of creating a secondary market where wagers can be bought and sold.

### 2. BACKGROUND OF THE INVENTION

The Supreme Court struck down the federal ban on sports betting in the United States in 2018, resulting in many US states legalizing sports betting and others in the process of legalization.

### 3. DESCRIPTION OF RELATED TECHNOLOGY

The standard process for placing a wager on a live event is as follows:

1. The customer makes a financial transaction with a casino or sportsbook (online or brick and mortar) on the event of their choice with the financial terms disclosed at the time of this transaction.
2. The customer receives a wager confirmation provided by the casino, which discloses the terms of the wager.
3. The event wagered on takes place and the results are final.
4. Once the event is finalized, the wager is graded a win or a loss, and any winning wager is paid out by the casino or sportsbook.
This process has been standard, but this invention will provide an additional, secondary market for customers looking to wager on live events.

### 4. SUMMARY OF THE INVENTION

This invention provides an additional market for customers looking to wager on live events, where the wagers that customers place in the casinos/sportsbooks can be bought and sold. From the time a customer places a wager, that wager can adjust in value before the event starts and during the event itself. In the current market, a customer cannot take advantage of the changes in value, because the payout only occurs after the event is final. This new market will act like an exchange where wagers are bought and sold, giving the betting customer the option to manage risk by taking a profit or minimizing loss, avoiding the “all or nothing” result of the current market, and entering and exiting the market as they choose. This market will not replace the current process in place for placing sports wagers (listed above); it will give the betting customer the option to add a step in the process. The betting customer will not be required to use this new market or be required to list their wagers on the exchange platform. It is at will, and a sale is only made if a buyer and seller agree. The wager can be listed on the exchange without the requirement to sell, and will receive offers from potential buyers.

Thus, the system acts to insert one important step between steps 2 and 3 in paragraph 3. The new step is Step 2.5: The wager is placed on an exchange where the wager holder will be able to sell the wager to a buyer.

The present invention requires a computer network to coordinate data and transactions among a number of parties: A “first bettor”, or wager transferor; the first bettor's casino or sportsbook; the first bettor's bank or other money account; a “second bettor”, or wager transferee; the second bettor's casino or sportsbook if there is one, and the second bettor's bank or other money account. Each of these parties uses a computer configured to perform the operations of this invention. The system of the present invention provides its own central computer configured to coordinate and/or record the activity of the system overall. It also provides multiple kiosks for interacting directly with the system at numerous locations.

### 5. BRIEF DESCRIPTION OF THE DRAWINGS

FIG. 1 depicts the topology of the computer network in a best mode.

FIG. 2 illustrates the exchange of data among computers in the network in the best mode implementation, wherein the casino is integrated into the market system.

FIG. 3 is a sample webpage visible to a second bettor on the system.

FIG. 4 illustrates the exchange of data among computers in the network, in an implementation wherein the casino is not integrated into the market system, and the bet wins.

FIG. 5 illustrates the exchange of data among computers in the network, in an implementation wherein the casino is not integrated into the market system, and the bet loses.

FIG. 6 illustrates the exchange of data among computers in the network, in an implementation wherein the first bettor sells the wager outright to the market.

FIG. 7 illustrates the exchange of data among computers in the network, in an implementation wherein the first bettor and the second bettor trade wagers.

FIG. 8 provides a tabular example of the escrow payment system.

### 6. DETAILED DESCRIPTION OF THE PREFERRED EMBODIMENTS

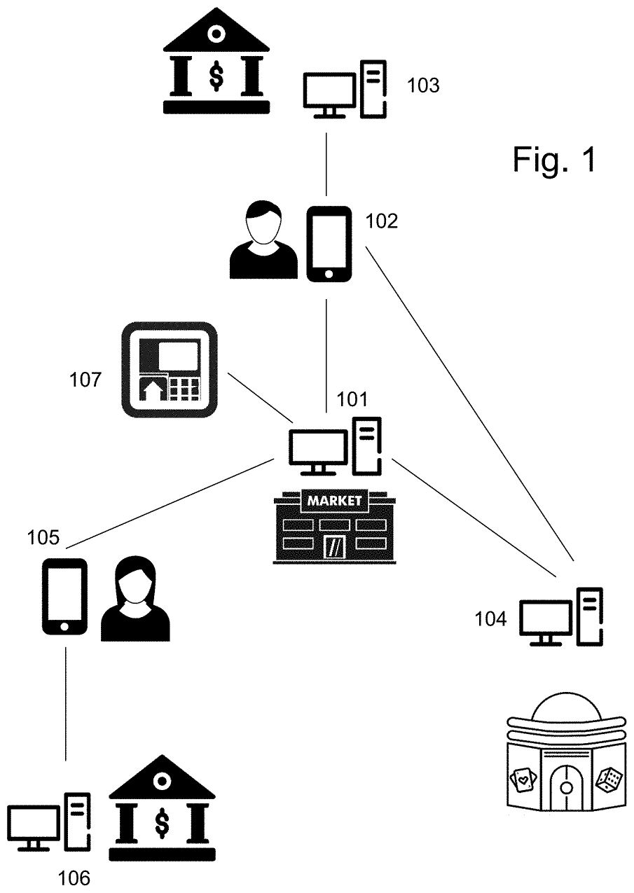

FIG. 1 depicts the topology of the computer network. The core of the system is a market for wager resale. The market has a market server 101 configured to coordinate all activity throughout the network. System participation requires at least one first bettor (male for the purposes of the present example), first bettor's computer 102, at least one casino with casino computer 104, and at least one second bettor (female for the purposes of the present example) with second bettor's computer 105. Each computer can, of course, assume the form of a cell phone, internet connected device, etc.

The first bettor accesses the system with first bettor's computer 102. First bettor has first market account on the market server. First bettor's computer and market server are configured (e.g. with an app) to exchange funds and information about first market account. First bettor has funds in an account at first bank, which is controlled by the first bank computer 103. First bettor's computer is configured to exchange data with the first bank computer and to authorize the transmission of funds to third parties, a well-known configuration that is not claimed by the present invention.

The casino deals in wagers. It may be a tangible traditional casino or an online sportsbook. The casino has a casino computer 104, which stores relevant information about each wager in a wager database. The fields of the wager database include the identity of the wager owner, the definition of the wager's success or failure, the price paid, and the payout amount. The probability of the wager's success, the time remaining until the wager is decided, and the market value of the wager are also included in the wager database, to the extent that they are known or estimated. The casino may or may not have a casino account on the market server. If it does, then the casino computer and the market server are configured to exchange funds and information about the casino account and the wager database.

The second bettor has second bettor's computer 105. Second bettor has second market account on the market server. Second bettor's computer and market server are configured (e.g. with an app) to exchange funds and information about second market account. Second bettor has funds in an account at second bank, which is controlled by the second bank computer 106. Second bettor's computer is configured to exchange data with the second bank computer and to authorize the transmission of funds to third parties, a well-known configuration that is not claimed by the present invention.

The system also provides at least one kiosk 107. The kiosk acts as a terminal, similar to an ATM, where first customer or second customer can interact with the system, the market, and their personal account on the market. The market server and the kiosk are configured to exchange funds and data about accounts on the market server.

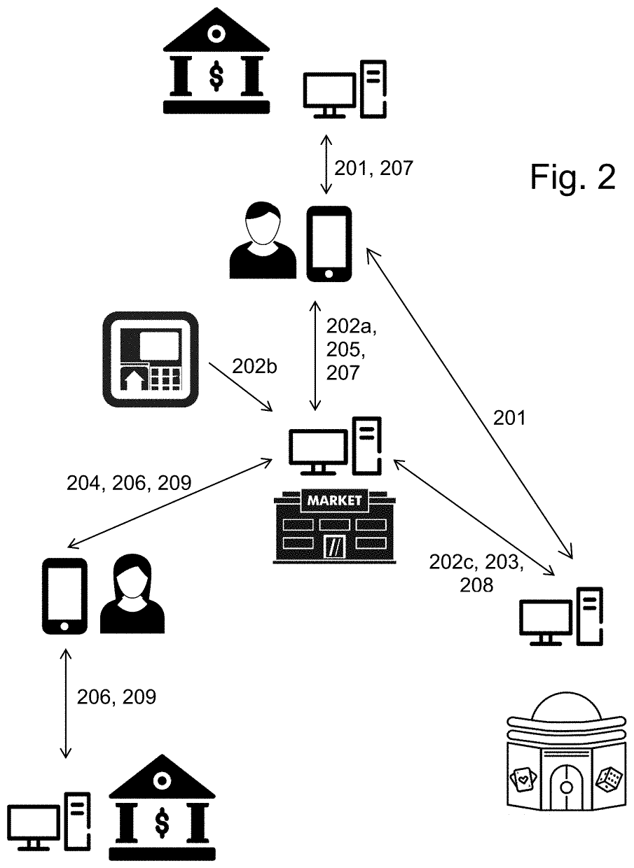

FIG. 2 illustrates the fundamental operation of the system in a best mode. Transactions are numbered approximately in chronological order. First, in transaction 201, the first bettor makes an initial purchase with the casino for a wager 301. The wager is a bet that a well-defined event will transpire, such as “Team A will win the game on August 3.” In this transaction, the first bettor's computer authorizes first bank's computer to transfer funds to the casino computer. In exchange, the casino's computer identities the first bettor as the wager owner and delivers a wager confirmation to first bettor's computer. The wager confirmation discloses well-defined financial terms. Those terms include, at a minimum, the identity of the first bettor, the definition of the event, the amount of first bettor's bet, and the amount that the casino will pay to the wager owner if the event occurs. The wager confirmation may optionally be printed on a paper ticket, in a format scannable by the kiosk as well as at the brick and mortar location.

Next, and critically before the underlying event is decided, the first bettor decides to offer his wager for sale. In transaction 202, the unsettled wager is uploaded to the market server. This wager may be uploaded from the first user's computer (transaction 202a) or from a kiosk (transaction 202b). The casino's computer can also be configured to transfer the wager confirmation directly to the market server automatically (202c). The first bettor's computer, the kiosk, and the market server are all configured for this transfer of information.

The market server posts the wager confirmation to a webpage that will be accessible to everyone on the market. The market server also submits notification to the casino computer that the wager is now on the market (transaction 203). The casino computer adds this information to the wager database. This information will trigger the casino to render payout to the purchaser/second bettor via the market server rather than to bettor 1, should the wager sell on the market.

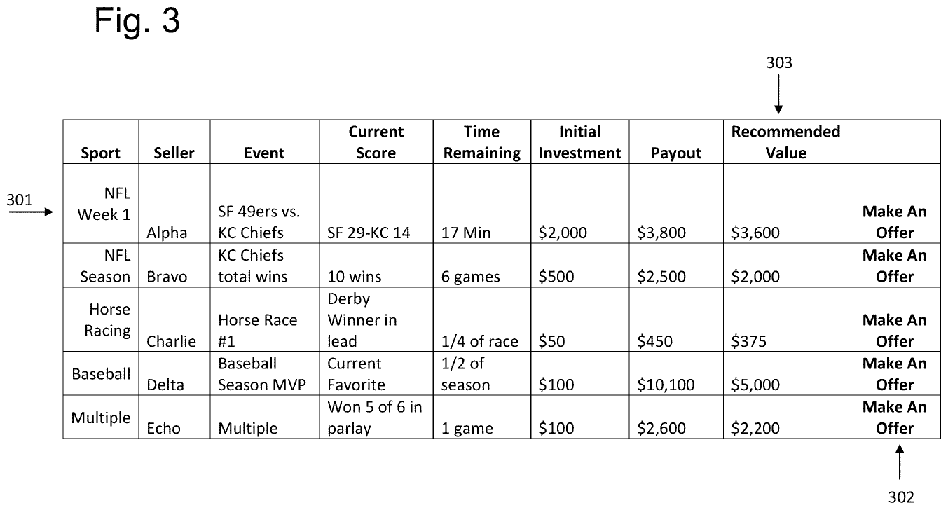

Next, the second bettor accesses the webpage where the wager 301 is listed for sale. When many participants are involved in the system, the second bettor will see a large list of available wagers that can be organized by sport, payout, types of wager and time until completion, as shown in FIG. 3. Each row of this table, like 301, represents a wager (this table is a short example; the actual list will cover a wide range of sports, live events, bet types and scenarios). Each column represents a field in the wager database. Those fields may include first bettor's username (Customer ID), Event, Current Score, Time Remaining, Initial Investment, Payout, Recommended Value, Type of bet, probability/odds, line, or other information. The Recommended Value 303 is generated by the system with an algorithm that may consider recent comparable transactions, probability, time, and other factors. Each offer also includes means for making an offer, 302.

If the second bettor is interested in purchasing the wager, she utilizes the means for making an offer 302, e.g. by pressing a “Make an Offer” button on a GUI on her computer. This initiates transaction 204, which submits a bid from the second bettor's computer to the market server. The bid includes her identifying information and her offer price. In the download of transaction 205, the market server then submits the bid to the first bettor's computer. The first bettor's computer is configured to alert the first bettor and to display the bid and means for the first bettor to accept or decline the bid.

If the first bettor accepts the second bettor's offer, he utilizes the means to accept the bid (e.g. an “Accept” button on a GUI). This completes the upload of transaction 205, in which the first bettor's computer transmits an instruction to the market server to accept the bid. The market server then updates the wager database by replacing the identification of the first bettor with the identification of the second bettor. Such replacement has the effect of transferring ownership from the first bettor to the second bettor, while keeping the record of the transfer for tracking purposes. In transaction 206, the second bettor's computer authorizes a transfer of funds from the second bettor's bank's computer to the market server for the purchase of a wager from the market. In transaction 207, the market server transfers these funds to the first bettor's bank's computer. The transfer of the wager is now complete.

If the wager then proves to be successful (“Team A wins”), the casino's computer transfers the payout to the market server (transaction 208) where it will remain until the second bettor chooses to withdraw it. The market server then routes the payout to the second bettor's bank's computer (transaction 209) should she choose to withdraw it from her account on the resell wager market. Bettors will be able to use funds on their resell wager account to fund all market activity and cover any potential payouts that arise from selling wagers on the market.

For clarity of understanding, two examples follow.

Example 1: A horse racing customer places a $100 wager on a horse that is 10-1, for a payout total of $1,100 through his local racetrack. He then places this wager on the wager exchange market through his mobile device. After the first quarter of the race, his horse is in the lead, and he receives an offer for his wager through his mobile device to sell the wager for $400. This first customer now has the option to take a profit on his investment and manage the risk that comes along with the final ¾ of the race. He accepts the sale and transfers the wager to the buyer, while he accepts the $400 and books a profit of $300, and cash of $400. The buyer of the wager has invested $400 and will receive the $1,100 payout should the horse win the race.

Example 2: A football customer places a $1,000 wager on his team to win the game for a total payout of $1,900. At halftime, his team is losing the game by 21 points. He decides to place this wager on the wager exchange market through his mobile device, to see if he can mitigate his losses. He receives an offer to sell his wager for $100. He accepts this offer and books a $900 loss on his investment rather than the original $1,000 outlay. The buyer of the wager is assuming great risk, but also the potential reward of a $1,900 payout on a $100 investment should the team come from behind and win the game.

The next few examples are variations on the previously disclosed best mode of the invention.

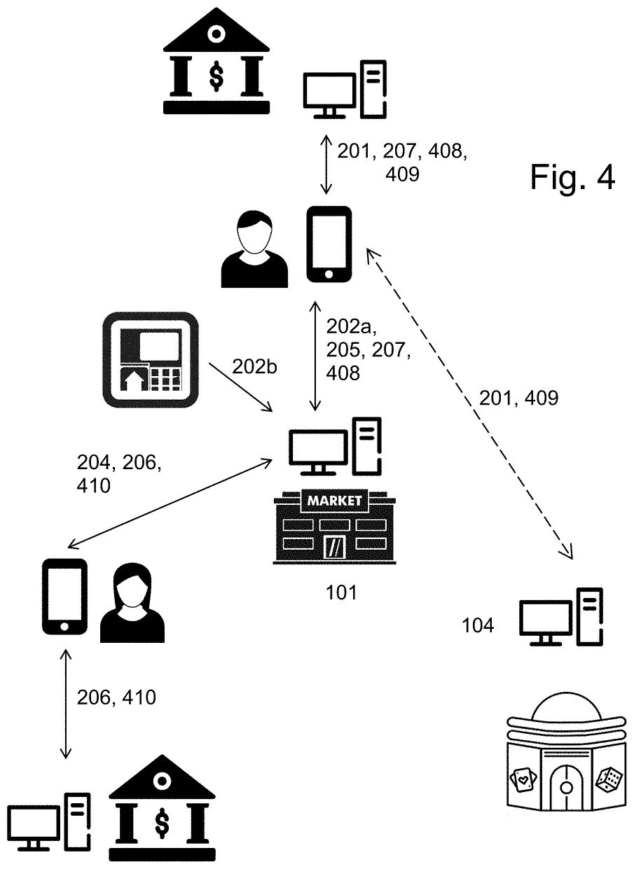

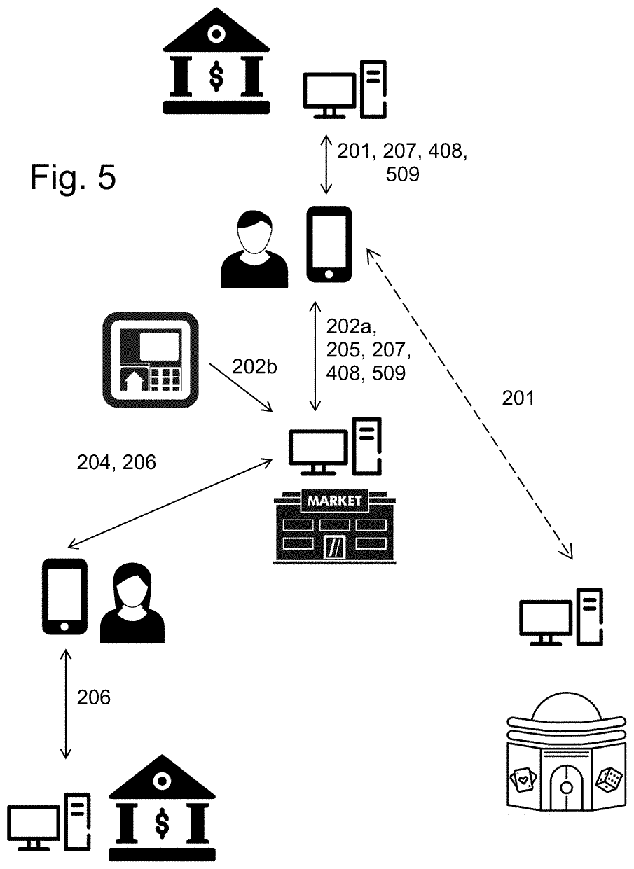

FIGS. 4 and 5 illustrate the case in which the wager did not originate with a casino integrated with the market. This would be the case if the first bettor obtained the wager from a non-participating casino, or if the first bettor is not betting against a casino at all. Note the lack of connection between casino's computer 104 and market server 101. The connection between the first bettor and the casino is now dashed to show that it is optional. In this case, following the first user's purchase of the wager confirmation 201, the first user must obviously upload the wager confirmation manually to the market server. The first user's computer, the kiosk, and the market server are configured to make this transaction as disclosed in steps 202a and 202b. The second better then purchases the wager confirmation in steps 204-207 as described above.

If the wager proves to be a winner, however, the casino computer is now unable to transfer funds into the system. Instead, these funds must come from the bettors' available funds in their wager account (which will be placed on hold), or from a loan from an affiliate of the resell wager market, or from their bank or credit card company, and placed into an escrow account on the market server. Before he can transfer his wager, the first bettor/wager seller, using first bettor's computer, must authorize a transfer of funds 408 equal to the payout amount from first bettor's bank's computer to market server. This transfer of funds is held in “escrow” in the market server. If the bet proves a winner, the casino's computer pays the payout amount to the first user, transaction 409. The casino is unaware of the second bettor or the market system. Meanwhile, the market server issues the payout from its escrow account to the second bettor, as shown in transaction 410.

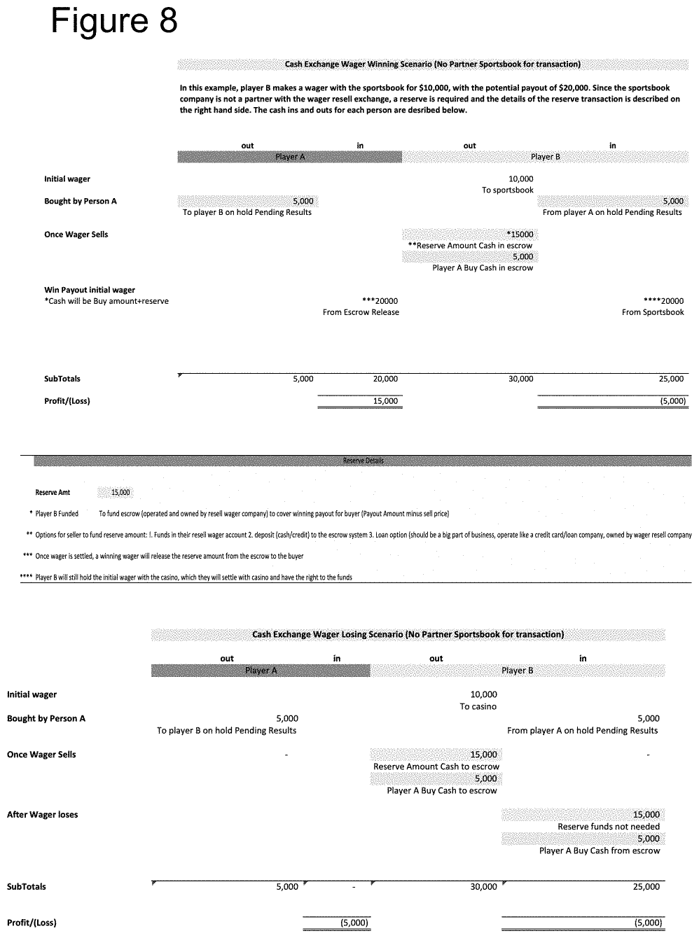

FIG. 5 shows the case in which the casino is not on the market and the wager proves to be a losing bet. The payout from the casino to the first bettor, 409, and from the market server (escrow) to the second bettor, 410, do not occur. Instead, the market server refunds the escrow funds back to the first bettor 509. See FIG. 8 for a numerical example.

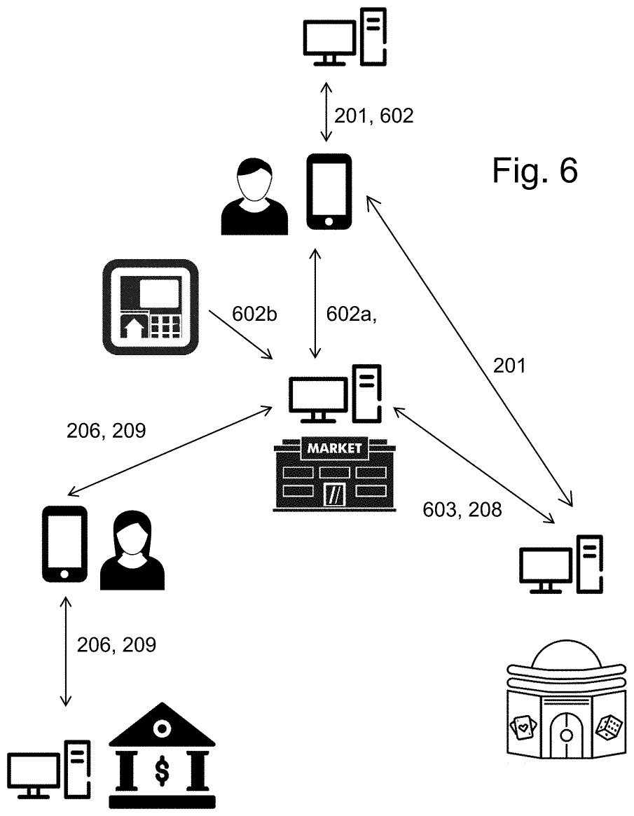

FIG. 6 shows a scenario in which the first bettor sells his wager outright to the market. This might be the first bettor's choice, for instance, when he does not feel confident that he can find a buyer; the market then assumes that risk. After initial purchase 201, the first bettor sells the wager to the market 602, whether as directed through first bettor's computer 602a or through a kiosk 602b. The market transfers a purchase amount to first bettor's bank's computer, and the first bettor is now finished. If the casino is integrated with the market server, then the market server notifies the casino 603 that the market now holds the wager. If second bettor decides to purchase the wager, her computer facilitates purchase 206, wherein she pays the market in exchange for the wager. In the case of a winning bet, the payout is transferred from casino to market 208 and then from market to second better 209.

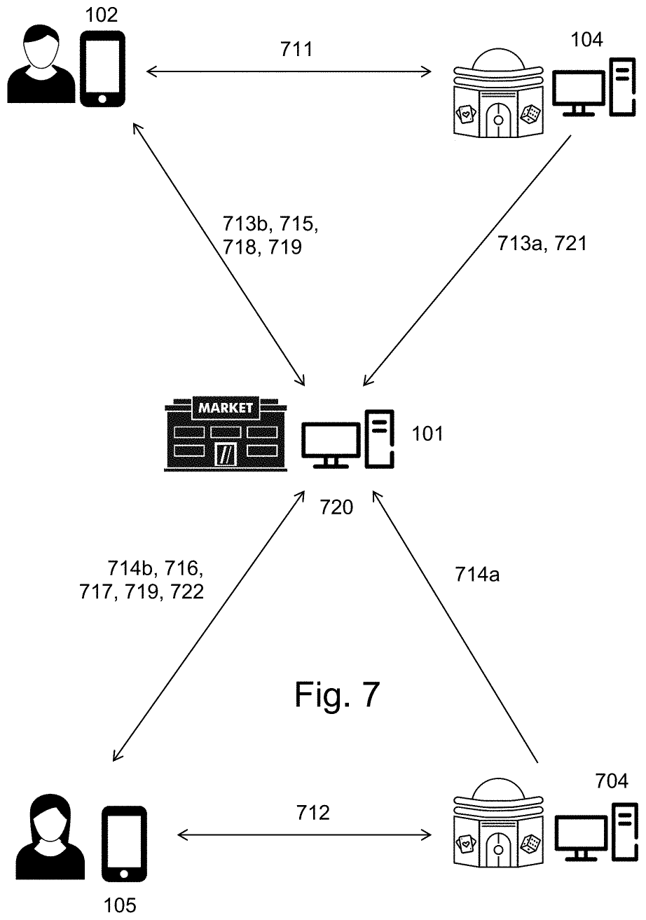

FIG. 7 depicts a “barter” method, a variation in which the bettors trade wagers. Here, the topology is slightly different from all the above because the second bettor is associated with a second casino, with second casino computer 704. Market server 101, first bettor's computer 102, first casino computer 104, and second bettor's computer 105 are depicted. The banks and the kiosk are omitted from this drawing for the sake of visual simplicity, though they are still part of the network.

The transactions in the barter system are depicted in FIG. 7 as well, numbered approximately in chronological order. In transaction 711, first bettor purchases first wager from first casino. Second bettor purchases second wager from second casino in transaction 712. The first wager is uploaded to the market server, either automatically by the first casino (713a) or manually by the first bettor (713b). The second wager is uploaded to the market server, either automatically by the second casino (714a) or manually by the second bettor (714b). First bettor is then able to see second wager for sale, and second bettor is able to see first wager for sale. In transaction 715, first bettor transmits an offer to trade first wager for second wager. This offer is transmitted from first bettor's computer to the market server. The offer may optionally include a proposed cash consideration representing the difference in value between the wagers. (For instance, if the first wager is worth more than the second wager, then the first bettor would offer to trade the first wager for the second wager plus additional cash). The offer is transmitted from the market server to the second bettor's computer in step 716. The second bettor sends an acceptance or counteroffer from second bettor's computer to the market server in step 717; this acceptance or counteroffer is conveyed from the market server to the first bettor's computer in step 718. If necessary, the negotiation of offers and counteroffers continues in like fashion. When the first and second bettors agree to the terms of the trade, the exchange of wagers and cash consideration are made over the network. One of the bettors submits cash consideration to the market. Here, that transaction is shown as step 719 from the second bettor to the market server and then to the first bettor's computer. The market server then interchanges the identities of the first and second bettors as owners of the first and second wagers in step 720. The payouts are then illustrated with the example of the first bet being a winner and the second bet being a loser. The first casino issues a payout to the market server in 721. The market server transmits the payout to the second bettor in 722.

I claim:

1. A web-based network for buying and selling wagers, comprising:
a market server and a first personal computer;
wherein the market server is configured to
host a market money account;
host a first user account associated with the first personal computer;
store a market wager database comprising at least one wager, each wager comprising the data fields of event, holder, and payout amount;
receive a first wager from the first personal computer, said first wager comprising first personal identification in the “holder” field;
update the “holder” field of the first wager to a market identification;
add the first wager to the market wager database;
and facilitate transfers of money balance between the market money account and the first user account;
and wherein the first personal computer is configured to
transmit the first wager to the market server;
and authorize transfers of money balance between the first user account and a first bank account.

2. The system of claim 1,
further comprising a kiosk configured to
scan the first wager and temporarily store the first wager;
transmit the first wager to the market server;
and facilitate transfers of money balance among the first user account, the first bank account, and the market money account;
and the market server is configured to receive the first wager from the kiosk.

3. The system of claim 2,
further comprising a second personal computer;
wherein the market server is configured to
host a second user account associated with the second personal computer;
post wagers from the wager database to a website;
receive an offer to buy the first wager from the second personal computer, said offer comprising the data fields of second personal identification and price;
receive an acceptance for said offer from the first personal computer;
transmit the acceptance to the second personal computer;
update the “holder” field of the first wager to second personal identification;
and facilitate transfers of money balance between the market money account and the second user account;
and the first personal computer is configured to
receive the offer from the market server;
transmit the acceptance for said offer to market server;
and the second personal computer is configured to
display the website on a graphical user interface, comprising a visualization of the first wager and means to make an offer for the first wager;
authorize transfers of money balance between the second user account and a second bank account;
transmit the offer to buy the first wager to the market server;
receive the acceptance from the market server;
and authorize a transfer of money balance equal to the price from the second user account to the market money account.

4. The system of claim 3, wherein
each wager further comprises the data field of “recommended value”;
the market server is configured to calculate a fair market value for each wager as a function of variables selected from the set of the payout amount, a probability of the event, a time remaining until the event is decided, and recent comparable transactions;
the “recommended value” field of the first wager is populated with a first fair market value;
and the graphical user interface provides means to set the price equal to the first fair market value.

5. The system of claim 4, wherein
the market server is further configured to
transmit the offer to the first personal computer;
transfer the payout amount from the market money account to the first user account in the event of a losing wager;
transfer the payout amount from the market money account to the second user account in the event of a winning wager;
and the first personal computer is further configured to
authorize a transfer of money balance equal to the payout amount from the first user account to the market money account simultaneously with acceptance of the offer;
and the second personal computer is further configured to
receive the acceptance from the market server;
display the acceptance on the graphical user interface.

6. The system of claim 5, further comprising a second wager, wherein
The market server is further configured to
receive the second wager from the second personal computer;
add the second wager to the wager database;
receive a barter offer from the first personal computer, said barter offer comprising the data fields of first wager, second wager, and barter price;
receive a barter acceptance from the second personal computer;
interchange the first personal identification and the second personal identification in the “holder” fields of the first wager and the second wager;
transfer a money balance in the amount of the barter price between the first user account and the second user account;
and the first personal computer is further configured to
display the website on a graphical user interface, comprising a visualization of the second wager and means to make the barter offer;
transmit the barter offer to the market server;
and the second personal computer is further configured to
transmit the second wager to the market server;
receive the barter offer from the market server;
transmit the barter acceptance to the market server;
authorize a transfer of money balance from the second user account to the market money account simultaneously with acceptance of the barter offer.

7. The system of claim 6, wherein
the first personal computer and the second personal computer are both further configured to receive counteroffers from the market server, to transmit counteroffers to the market server, and to accept counteroffers from the market server;
the market server is further configured to relay counteroffers between the first personal computer and the second personal computer.

8. The system of claim 7, further comprising a first casino computer associated with the first personal computer, wherein
the market server is further configured to
host a first casino account;
receive the first wager from the first casino computer;
transmit updates of the first wager to the first casino computer;
and facilitate a transfer of money balance in the amount of the first wager payout from the first casino account to the market money account;
and the first casino computer is configured to
store a first casino wager database comprising at least one wager;
add the first wager to the first casino wager database;
transmit the first wager to the first personal computer and to the market server;
receive updates of the first wager from the market server;
and authorize transfers of funds to and from the first casino account;
and the first personal computer is further configured to receive the first wager from the first casino computer.

9. The system of claim 8, further comprising a second casino computer associated with the second personal computer, wherein
the market server is further configured to
host a second casino account;
receive the second wager from the second casino computer;
transmit updates of the second wager to the second casino computer;
and facilitate a transfer of money balance in the amount of the second wager payout from the second casino account to the market money account;
and the second casino computer is configured to
store a second casino wager database comprising at least one wager;
add the second wager to the second casino wager database;
transmit the second wager to the second personal computer and to the market server;
receive updates of the second wager from the market server;
and authorize transfers of funds to and from the second casino account;
and the second personal computer is further configured to receive the second wager from the second casino computer.

10. A process for buying and selling wagers over an internet system, comprising the steps of:
providing
a market server, a first personal computer, a market money account hosted on the market server, a first user account associated with the first personal computer and hosted on the market server, and a market wager database hosted on the market server, said wager database comprising the fields of “event”, “holder”, and “payout amount”;
transmitting a first wager from an internet-connected computer to the market server, said first wager comprising first personal identification in the “holder” field;
updating the “holder” field of the first wager to a market identification;
adding the first wager to the market wager database;
and transferring a money balance from the market money account to the first user account.

11. The process of claim 10, wherein the internet-connected computer is the first personal computer.

12. The process of claim 10,
further comprising the steps of
providing a kiosk;
scanning the wager into the kiosk;
and wherein the internet-connected computer is the kiosk.

13. The process of claim 10,
further comprising the steps of
providing
a second personal computer, a second user account associated with the second personal computer and hosted on the market server, and a web site with graphical user interface;
posting wagers from the wager database to the website;
displaying the website with graphical user interface on the second personal computer;
transmitting an offer to buy the first wager from the second personal computer to the market server, said offer comprising the data fields of second personal identification and price;
transmitting the offer from the market server to the first personal computer;
transmitting an acceptance for said offer from the first personal computer to the market server;
transmitting the acceptance from the market server to the second personal computer;
changing the “holder” field of the first wager to second personal identification;
transferring a money balance from the second user account to the first user account in the amount of the price;
and transferring a money balance from the market money account to the second user account in the amount of the payout after the event occurs.

14. The process of claim 13,
wherein each wager further comprises the data field of “recommended value”;
and further comprising the steps of
calculating a fair market value for each wager as a function of variables selected from the set of the payout amount, a probability of the event, a time remaining until the event is decided, and recent comparable transactions;
populating the “recommended value” field of the first wager with a first fair market value;
setting the price equal to the first fair market value.

15. The process of claim 14, further comprising the steps of
transferring a money balance equal to the payout amount from the first user account to the market money account simultaneously with transmission of the acceptance from the first personal computer to the market server;
transferring a money balance equal to the payout amount from the market money account to the first user account after the event fails to occur.

16. The process of claim 15, further comprising the steps of
providing a second wager;
transmitting the second wager from the second personal computer to the market server;
adding the second wager to the wager database;
displaying the website with graphical user interface on the first personal computer;
transmitting a barter offer from the first personal computer to the market server, said barter offer comprising the data fields of first wager, second wager, and barter price;
transmitting the barter offer from the market server to the second personal computer;
transmitting a barter acceptance from the second personal computer to the market server;
transmitting the barter acceptance from the market server to the first personal computer;
interchanging the first personal identification and the second personal identification in the “holder” fields of the first wager and the second wager;
and transferring a money balance in the amount of the barter price between the first user account and the second user account.

17. The process of claim 16, further comprising the steps of
providing a revised barter price;
transmitting a counteroffer from the second personal computer to the market server, said counteroffer comprising the revised barter price;
and transmitting the counteroffer from the market server to the first personal computer.

18. The process of claim 14,
further comprising the step of providing a first casino computer;
and wherein the internet-connected computer is the first casino computer.

19. The process of claim 17,
further comprising the step of providing a lender account;
and wherein the first user account draws the money balance from the lender account before transferring the money balance to the market money account.
